(19) United States
(12) Patent Application Publication
(10) Pub. No.: US 2009/0024317 A1
(43) Pub. Date: Jan. 22, 2009

(54) System for gathering and distributing location information of vehicles

(75) Inventors: Jan H. Aase, Oakland Township, MI (US); Branden G. Neish, Shelby Township, MI (US)

Correspondence Address: Quinn Law Group, PLLC, 39555 Orchard Hill Place, Suite 520, Novi, MI, 48375, US

(73) Assignee: GM Global Technology Operations, Inc., Detroit, MI (US)

(21) Appl. No.: 12/142,253

(22) Filed: Jun. 19, 2008

Related U.S. Application Data
(60) Provisional application No. 60/950,540, filed on Jul. 18, 2007.

(51) Int. Cl. G01C 21/36

(52) U.S. Cl. 701/209; 340/989; 701/300

(57) ABSTRACT

A vehicle has a navigation system including a controller, a display, a wireless transmitter/receiver and a global positioning unit to determine the location of the navigation system. The controller is configured to transmit, to an off-vehicle system the location of the navigation system, a unique identifier of the navigation system and a list of other navigation systems. In addition, the controller is configured to receive, via the transmitter/receiver, the location of any other navigation systems which listed that navigation system and to display the locations of the other navigation systems on the display.

### CROSS-REFERENCE TO RELATED APPLICATIONS

This application claims the benefit of U.S. Provisional Application No. 60/950,540, filed Jul. 18, 2007, which is hereby incorporated by reference in its entirety.

### TECHNICAL FIELD

The present invention relates generally to a vehicle navigation system for automobiles and more specifically to the vehicle navigation system using information regarding other vehicle navigation systems.

### BACKGROUND OF THE INVENTION

Conventional vehicle navigation systems include a global positioning system. The global positioning system is used to determine the location of the vehicle the navigation system is associated with. The vehicle location information generated by the global positioning system is then used by the navigation system to perform various functions, such as displaying the vehicle's location or providing directions to a selected location. The use of navigation systems within vehicles has become more popular in recent years. However, conventional navigation systems operate independently of other navigation systems.

### SUMMARY OF THE INVENTION

A vehicle navigation system which receives information regarding other navigation systems and provides data to the other navigation systems is desired.

A vehicle has a navigation system including a controller, a display, a wireless transmitter/receiver and a global positioning unit. The global positioning unit is configured to determine the location of the navigation system and to transmit the location of the navigation system to the controller. Upon receiving the information the controller is configured to transmit, to an off-vehicle system via the wireless transmitter/receiver, the location of the navigation system and a unique identifier of the navigation system. The controller transmits the information to any other navigation systems which an operator of the vehicle has indicated. In addition, the controller is configured to receive, via the transmitter/receiver, the location of any other navigation systems which have transmitted information and to display the locations of the other navigation systems on the display.

The above features and advantages, and other features and advantages of the present invention will be readily apparent from the following detailed description of the preferred embodiments and best modes for carrying out the present invention when taken in connection with the accompanying drawings.

### BRIEF DESCRIPTION OF THE DRAWINGS

FIG. 1 is a schematic illustration of a vehicle with a vehicle navigation system;

FIG. 2 is a schematic illustration of a system having multiple vehicles using the vehicle navigation system of FIG. 1; and

FIG. 3 is a schematic illustration of a display for use with the navigation system of FIG. 1.

### DESCRIPTION OF THE PREFERRED EMBODIMENTS

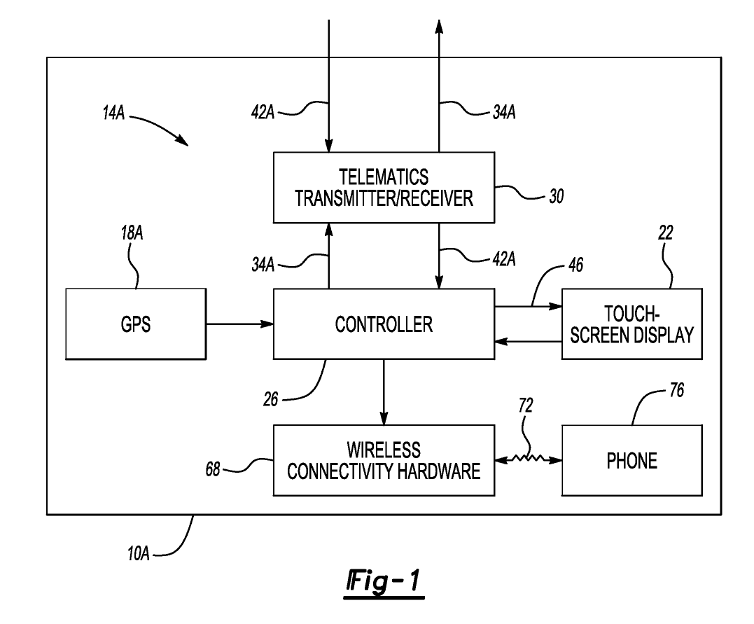

Referring to the Figures, wherein like reference numbers refer to the same or similar components throughout the several views, FIG. 1 illustrates a schematic view of a vehicle 10A which includes a navigation system 14A. The navigation system (or unit) 14A includes a global positioning system (GPS) unit 18A, a touch-screen display 22, a controller 26, and a telematics transmitter/receiver 30. The controller 26 includes a microprocessor, a data storage medium, and appropriate input and output circuits of a known type for receiving various input signals and transmitting various output signals. The controller 26 may be dedicated to the navigation system 14A, or may also be part of other systems. For example, the controller 26 may be a body control module or a general purpose controller. The GPS unit 18A, the display 22 and the transmitter/receiver 30 are each in communication with the controller 26. The GPS unit 18 is configured to determine the location of the vehicle 10A, as understood by those skilled in the art, and to transmit the location of the vehicle 10A to the controller 26.

The touch-screen display 22 functions as an interface between the navigation system 14A and an occupant of a passenger compartment of the vehicle 10A. In addition, the touch-screen display 22 functions as an output device for the navigation system 14A by visually displaying information that is received from the controller 26. Additionally, the touch -screen display 22 functions as an input device. The occupant of the passenger compartment of the vehicle 10A can input information by touching the touch-screen display 22, as understood by those skilled in the art. The input information is then sent to the controller 26.

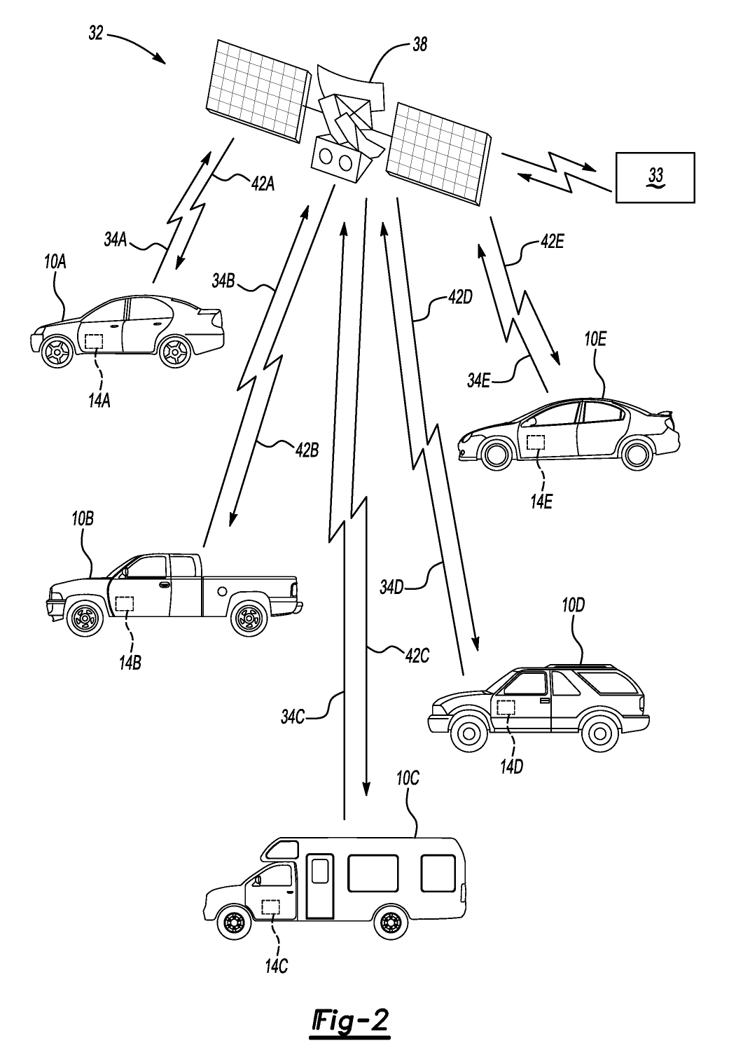

The navigation system 14A is configured to be used with a system (shown at 32 in FIG. 2) for collecting and distributing location information among a plurality of navigation systems. Referring to FIG. 2, a plurality of vehicles 10A-E are schematically illustrated. Each of the vehicles 10A-E includes a respective navigation system 14A-E. The navigation systems 14B-E are substantially similar to the navigation system 14A, described herein. Each of the navigation systems 14B-E includes at least a GPS unit, substantially similar to GPS unit 18A. Each of the navigation systems 14A-E is also characterized by a unique identifier. The unique identifier is used by the system 32 to identify and distinguish each of the vehicles 10A-E and their respective navigation systems 14A-E.

The unique identifier of each navigation system 14A-E may, for example, be a string of alphanumeric characters. A unique identifier may be dedicated to each particular navigation system 14A-E. Alternatively, a unique identifier may be dedicated to a particular consumer, and input into one of the navigation systems 14A-E to identify the consumer that is using the navigation system 14A-E.

Referring again to FIG. 1, the controller 26 is configured to selectively transmit system data 34A in electronic form to the transmitter/receiver 30, which the transmitter/receiver 30 transmits in wireless form to a satellite (shown at 38 in FIG. 2). The system data 34A includes the location of the vehicle 10A as determined by the GPS unit 18, the unique identifier of the navigation system 14A, and a list of the other navigation systems (shown at 14B-E in FIG. 2) to which the information and location of the vehicle 10A (and, correspondingly, the navigation system 14A) is to be transmitted. The navigation systems 14B-E in the list are identified in the system data 34A by their respective unique identifiers, which are provided to the controller 26 by a consumer via the touch-screen display 22. The list may include all of the other navigation systems 14B-E, only some of the other navigation systems 14B-E, or none of the other navigation systems 14B-E.

It should be noted that, in the situation where the unique identifiers are dedicated to individual consumers, the consumer using the navigation system 14A-E inputs the consumer's unique identifier to the controller 26 via the touch-screen display 22, or by means of a unique rf identifier such as a keyfob or rfID transmitter. Accordingly, in such a situation, the unique identifier of the navigation system 14A is the unique identifier input by the consumer using the navigation system 14A, and this information becomes part of the system data 34A. By having unique identifiers assigned to individual consumers rather than the navigation systems 14A-E, an individual consumer can use multiple vehicles and multiple navigation systems 14A-E and use the consumer's unique identifier with each of the navigation systems 14A-E.

Referring again to FIG. 2, the navigation systems 14B-E associated with the vehicles 10B-E each transmit respective system data 34B-E to the satellite 38. The system data 34B-E includes a similar type of information as the system data 34A. That is, the system data 34B would include the location of the vehicle 10B as determined by the GPS unit 18B of the navigation system 14B, the unique identifier of the navigation system 14B, and a list of the other navigation systems 14A, 14C-E to which the information and location of the vehicle 10B (and, correspondingly, the navigation system 14B) is to be transmitted. The system data 34C would include the location of the vehicle 10C as determined by the GPS unit of the navigation system 14C, the unique identifier of the navigation system 14C, and a list of the other navigation systems 14A-B 14D-E to which the information and location of the vehicle 10C (and, correspondingly, the navigation system 14C) is to be transmitted. The system data 34D would include the location of the vehicle 10D as determined by the GPS unit of the navigation system 14D, the unique identifier of the navigation system 14D, and a list of the other navigation systems 14A-C, 14E to which the information and location of the vehicle 10D (and, correspondingly, the navigation system 14D) is to be transmitted. The system data 34E includes the location of the vehicle 10E as determined by the GPS unit of the navigation system 14E, the unique identifier of the navigation system 14E, and a list of the other navigation systems 14A-D to which the information and location of the vehicle 10E (and, correspondingly, the navigation system 14E) is to be transmitted.

The system 32 has a system controller 33 that manages the system data 34A-E received by the satellite 38 from the vehicles 10A-E. The system 32 transmits location data 42A-E of the navigation systems 14A-E, respectively, to the other navigations systems 14A-E which are included on each of the respective lists of the system data 34A-E. The location data 42A, transmitted to the navigation system 14A, includes the unique identifier and the location of any of the navigation systems 14B-E that identified the navigation system 14A in the list transmitted in the system data 34B-E. The location data 42B, transmitted to the navigation system 14B, includes the unique identifier and the location of any of the navigation systems 14A, C-E that identified the navigation system 14B in the list transmitted in the system data 34A, C-E. The location data 42C, transmitted to the navigation system 14C, includes the unique identifier and the location of any of the navigation systems 14A-B, D-E that identified the navigation system 14C in the list transmitted in the system data 34A-B, D-E. The location data 42D, transmitted to the navigation system 14D, includes the unique identifier and the location of any of the navigation systems 14A-C, E that identified the navigation system 14D in the list transmitted in the system data 34A-C, E. The location data 42E, transmitted to the navigation system 14E, includes the unique identifier and the location of any of the navigation systems 14A-D that identified the navigation system 14E in the list transmitted in the system data 34A-D.

Referring again to FIG. 1, the transmitter/receiver 30 receives the location data 42A from the satellite 38 as a radio frequency signal, and then transmits the location data 42A within the navigation system 14A as an electronic signal to the controller 26. The controller 26 is configured to transmit a signal 46 including at least a portion of the location data 42A to the display 22. The display 22 uses the information from the signal 46 to indicate the location of the vehicle 10A, as determined by the GPS unit 18. Additionally, the signal 46 includes the locations of the other navigation systems received in the location data 42A.

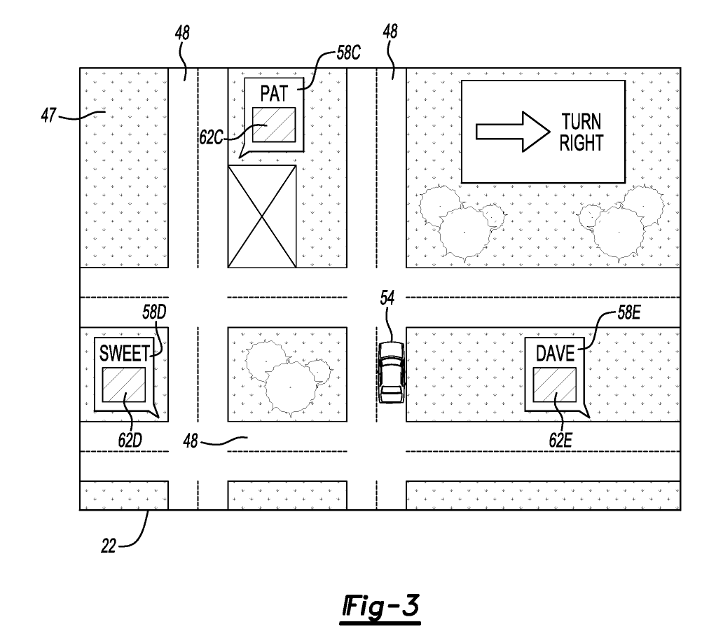

Referring to FIG. 3, wherein like reference numbers refer to like components from FIGS. 1 and 2, the controller 26 and display 22 are illustrated. The controller 26 causes the display 22 to display a map 47 including representations 48 of streets. The controller 26 also instructs the display 22 to show an icon 54 indicating the location of the vehicle 10A on the map 47. Additionally, the controller 26 instructs the display 22 to show the locations on the map 47 of all the navigation systems 14B-E that identified the navigation system 14A in their lists transmitted in the system data 34A-D.

For example, if the system data 34C, that is transmitted by the navigation system 14C, included the navigation system 14A in the list of the system data 34C, then the locating data 42A, sent from the satellite 38, would include the unique identifier and location of the navigation system 14C. The controller 26 matches the unique identifier of the navigation system 14C to a name 58C (e.g. “PAT”) and an icon 62C. The name 58C and the icon 62C are stored in a data storage medium (not shown) and are preselected or predetermined to represent the navigation system 14C. The controller 26 then causes the display 22 to show the name 58C and the icon 62C on the map 47 at the location of the navigation system 14C, as reported in the locating data 42A. Similarly, if the system data 34D and 34E included the navigation system 14A in their respective lists, then locating data 42A, sent from the satellite 38, would include the unique identifiers and locations of the navigation systems 14D and 14E. The controller 26 would retrieve from the data storage medium (not shown) the names 58D (e.g. “SWEET”), 58E (e.g. “DAVE”) and the icons 62D, 62E corresponding to the unique identifiers for the navigation systems 14D, 14E previously predetermined and input in the memory. The controller would instruct the display 22 to indicate the locations of navigation systems 14D and 14E on the map 47 with names 58D, 58E and icons 62D, 62E, respectively, at the location of the navigations systems 14D and 14E, as reported in the locating data 42.

Alternatively, and within the scope of the claimed invention, the system 32 may be configured such that the names 58A-E and the icons 62A-E corresponding to the navigation systems 14A-E may be included in the location data 42A-E. Any of the navigation systems 14B-E that did not include navigation system 14A in the list with the system data 34A-E would not appear on the map 47 since the location data 42A received by the controller 42A would not include the locations of those navigation systems 14B-E. A consumer could remain “unseen” by all of the other navigation systems 14A-E by simply not including any of the other navigation systems 14A-E on the list with the system data 34A-E. Further the consumer may have the option of temporarily removing other navigation system 14A-E from the list, to temporarily suspend visibility by the other navigations system 14A-E. The display 22 may contain such a setting to make a temporary “unseen” status easy to employ.

The navigation system 14A is also configured to provide directions from the vehicle 10A to any of the vehicles 10B-E and the navigation systems 14B-E represented by the 62B-E icons on the display 22. For example, in an exemplary embodiment, touching the display 22 at one of the icons 62B-E will cause the display 22 to show the distance and directions from the vehicle 10A to the vehicle 10B-E and the navigation system 14B-E represented by the selected icon 62B-E.

Referring again to FIG. 1, the controller 26 is operatively connected to wireless connectivity hardware 68 which is configured to selectively establish a wireless connection 72 to a cellular telephone 76 so that the cellular telephone 76 is controllable by the controller 26. The controller 26 is programmed to cause the telephone 76 to call a telephone (not shown) of the consumer operating one of the navigation systems 14A-E identified in the locating data 42A in response to an occupant command via the touch-screen display 22. For example, the controller 26 may cause the telephone 76 to call the consumer operating the navigation system 14C in response to the display 22 being touched twice at the icon 62C. The telephone number of the consumer operating the navigation system 14C may, for example, be preprogrammed by the occupant of the passenger compartment of the vehicle 10A, or may be included in the location data 42A.

Operation of the navigation systems 14B-E is substantially identical to the operation of the navigation system 14A. The system 32 includes a data processor (not shown) which may be on the satellite 38 (shown in FIG. 2) or may be ground based and in communication with the satellite 38 to process the system data 34A-E and to generate the location data 42A-E to be sent to the navigations systems 14A-E. The system 32 may also include data storage which may, for example, store a telephone number and icon for each unique identifier, and transmit in the location data 42A-E the telephone number and icon of each unique identifier included in the system data 34A-E.

While the best modes for carrying out the invention have been described in detail, those familiar with the art to which this invention relates will recognize various alternative designs and embodiments for practicing the invention within the scope of the appended claims.

1. A navigation system comprising:
a controller;
a display;
a wireless transmitter/receiver;
a global positioning unit configured to determine the location of the navigation system and to transmit the location of the navigation system to the controller;
wherein the controller is configured to transmit, to an external system via the transmitter/receiver, the location of the navigation system, a unique identifier of the navigation system, and a list of other navigation systems to which an operator desires to transmit the location of the navigation system; and
wherein the controller is configured to receive, via the transmitter/receiver, the location of the other navigation systems and to display the locations of the other navigation systems on the display.

2. The navigation system of claim 1, further comprising wireless connectivity hardware operatively connected to the controller and through which the controller can selectively control a cellular telephone.

3. The navigation system of claim 2, wherein the controller is configured to selectively cause the telephone to call a telephone number corresponding to one of the other navigation systems.

4. The navigation system of claim 1, wherein the controller is configured to receive unique identifiers of the other navigation system and wherein a name and icon are associated with each of the unique identifiers of the other navigation systems.

5. The navigation system of claim 1, wherein the controller is configured to display a distance and directions to any one of the other navigation systems.

6. A system for managing vehicle information comprising:
a plurality of vehicles wherein each of the vehicles has a navigation unit comprising:
a navigation unit controller, including an unique identifier for the navigation unit and a list of other navigation units recorded therein;
a display;
a wireless transmitter/receiver;
a global positioning unit configured to determine the location of the navigation unit and to transmit the location of the navigation unit to the navigation unit controller;
a system controller, wherein the system controller is configured to receive, via the respective transmitter/receivers, the respective location, the respective unique identifier, and the respective list of other navigation units;
wherein the system controller is configured to transmit, to each of the navigation units, via the respective transmitter/receiver, the locations of those of the other navigation units listing that respective navigation unit.

7. The system of claim 6, wherein the navigation unit for each of the plurality of vehicles is configured to display on the display the locations transmitted by the system controller of the other navigation units.

8. The system of claim 6, wherein the navigation unit for each of the plurality of vehicles further comprises wireless connectivity hardware operatively connected to the navigation unit controller and through which the navigation unit controller can selectively control a cellular telephone.

9. The system of claim 8, wherein the navigation unit controller for each of the plurality of vehicles is configured to selectively cause the telephone to call a telephone number, corresponding to one of the other navigation systems, via the system controller.

10. The system of claim 6, wherein the navigation unit controller for each of the plurality of vehicles is configured to receive the unique identifiers of the other navigation units and wherein a name and icon are associated with each of the unique identifiers of the other navigation units.

11. The system of claim 6, wherein the navigation unit controller for each of the plurality of vehicles is configured to display a distance and directions to any one of the other navigations systems.

12. A method for operating a system comprising:
providing a plurality of vehicles each having a navigation unit;
determining the location for each of the plurality of vehicles using the respective navigation unit;
transmitting to a system controller from each of the plurality of vehicles the location of the respective navigation unit and a respective pre-selected list of other vehicles;
transmitting the locations of the respective navigation units from the system controller to the respective navigation unit for each of the vehicles on the pre-selected lists.

13. The method of claim 12, further comprising receiving, from the system controller, a unique identifier for each of the respective navigation units for which a location was transmitted.

14. The method of claim 13, further comprising:
associating a name and icon with each of the unique identifiers; and
displaying the name and icon, on a display for the respective navigation unit.

15. The method of claim 14, further comprising displaying a distance and directions to the respective navigation unit for one of the other plurality of vehicles.

16. The method of claim 12, further comprising controlling a cellular telephone connected to the respective navigation unit using wireless connectivity hardware operatively connected to the respective navigation unit.

17. The method of claim 16, further comprising calling a telephone number, wherein the telephone number corresponds to a cellular telephone connected to one of the respective navigation units for which a location was transmitted.
